(19) United States
(12) Patent Application Publication
(10) Pub. No.: US 2007/0153502 A1
(43) Pub. Date: Jul. 5, 2007

(54) System for signalling and/or decorative lighting on technical floors

(76) Inventor: Miguel Angel Floria Arriazu, Zaragoza (ES)

Correspondence Address: WILLIAM COLLARD;COLLARD & ROE, P.C., 1077 NORTHERN BOULEVARD, ROSLYN, NY, 11576, US

(21) Appl. No.: 11/603,751

(22) Filed: Nov. 22, 2006

(30) Foreign Application Priority Data
Nov. 23, 2005 (ES) P 2005 02881

(51) Int. Cl. F21S 8/00

(52) U.S. Cl. 362/152; 362/153

(57) ABSTRACT

System for signalling and/or decorative lighting on technical floors, on the type of floors comprising a number of height-adjustable legs connected by means of girders forming a horizontal network structure which may be levelled, on which a number of floor-creating plates are set and comprises a number of luminous or luminescent elements arranged so as to notice their illumination, protected in several holes made inside or between the plates forming the technical floor, power being supplied to them through the corresponding wiring from a preferably safe power supply.

### OBJECT OF THE INVENTION

The present invention refers to a system for signalling and/or decorative lighting on technical floors.

### BACKGROUND OF THE INVENTION

Technical floors made up of several legs adjustable in height are familiar with, connected by girders forming a horizontal, networked structure, upon which plates are supported to create the floor, normally made of aggregate covered by a tile of different materials.

The floor stays perfectly levelled thanks to the regulation in height of the legs. On some of these floors, the girders have a wing that juts out lengthways above between the plates, which makes a small separation equal to the wing thickness.

These plates, and the structure in general, are raised with regard to the base or real floor, permitting the installation of wiring or other fittings between them, that are easily accessible by raising the plates that make the technical floor.

On the other hand, in many obligatory cases, the use of various signalling means in public or private buildings to indicate, for example, emergency escape routes (fire, blackout, etc.), are known.

For obvious reasons of difficulty in carrying out wiring and protection of lamps, light signalling is normally fitted in high places where it also seems to be more visible.

However, this is not the case in certain conditions, as, for example, in fires where the smoke tends to go upwards and may hide or hinder one from seeing these ominous signals placed above.

These inconveniences are overcome by the use of the system referred to in this invention.

### DESCRIPTION OF THE INVENTION

The system referred to in the invention installs luminous signalling on technical floors in the best possible way, extremely useful, for example, to signal emergency escape routes or nocturnal lighting, to indicate emergency exits, or to provide information regarding conditions of luminous tonality or flashing changes, and useful in a great variety of information-providing applications. Besides, it is also useful in fulfilling an aesthetic function.

According to the invention, the system comprises a number of luminous or luminescent elements fitted inside holes provided in the technical floor, suitably protected so that their illumination is visible, in order to, for example, be used as emergency signalling or decorative lighting.

The holes where the luminous or luminescent elements are housed may be fitted into the plates forming the technical floor themselves or, preferably, in holes arranged between adjacent plates, for example, by means of separators, chamfers, etc. In addition, they will be ideally included in the stands of the network structure, since the implementation of specific supports is avoided in this way.

Luminous or luminescent elements of different shapes and colours may be used in adapting them to the holes or to improve their visualization or aesthetics. To the latter end, the use of luminous diffusers might also be interesting. Therefore, the luminous or luminescent elements, or the diffusers, may have, for example, a cross, diamond or round shape, etc.

Ideally, one or more LED diodes shall be used, powered by the corresponding wiring, and preferably from a safe power source that enables its functioning even in the case of normal electrical power supply failure.

The wiring is to be preferably undertaken in a such way as to allow the power supply of sets of diodes selectively or individually, to indicate routes, establish effects selectively with information-providing purposes, etc.

On the luminous or luminescent elements lighting up, luminous signalling is established at the corners of the floor-creating plates—signalling that is easily perceptible to the user.

### BRIEF DESCRIPTION OF THE DRAWINGS

FIG. 1 shows a view of a section of technical floor that incorporates the system in the invention.

FIG. 2 shows a detailed view of a technical floor's adjustable leg, where the elements fitted into it according to the invention are displayed.

FIG. 3 shows an embodiment variation of the system referred to in the invention, with a luminous diffuser.

### DESCRIPTION OF A PRACTICAL EMBODIMENT OF THE INVENTION

The system in the invention comprises a number of luminous diffusers 1 with transparency index between 72 and 89%, which have an cross-shape to be inserted into the space in such a way as to define other height-adjustable legs 2 that form part of the structure of the technical floor. In this embodiment example, restrictive in no case, the structure's girders 3 are joined to the legs by means of nipples 4 with a head 5 that is inserted through a slot 6 with reduced edges of the leg, that has a setscrew 8 tightening area 7 for each girder.

Since the girders have an upper wing 9 that makes a separation between the floor-creating plates 9a, wings that do not continue over the legs, it is precisely in this area where the diffusers are to be fitted, providing continuity in turn to the surface area of the floor. In turn, each plate 9a is made up of a base 9b of high-density agglomerate to which a tile 9c is mechanically fixed or by means of adhesive.

In a variation of the invention, it has been considered that the diffuser has a T-shape, as shown in FIG. 3, to be inserted into the legs the technical floor may have around its perimeter, for example adjacent to walls or other floors.

The diffuser is to be ideally embodied with high transparency material but tinting its upper faces to increase its visualization through illumination, not through light dispersion.

Under each diffuser is a luminous or luminescent element, an LED 10 in this example, which is inserted into a cavity 11 of the diffuser itself. This could be a single or multicoloured LED.

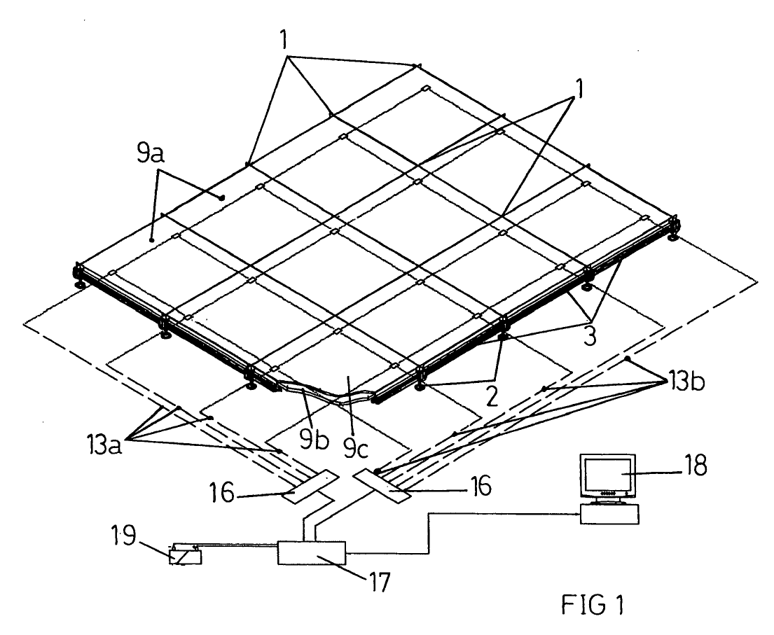

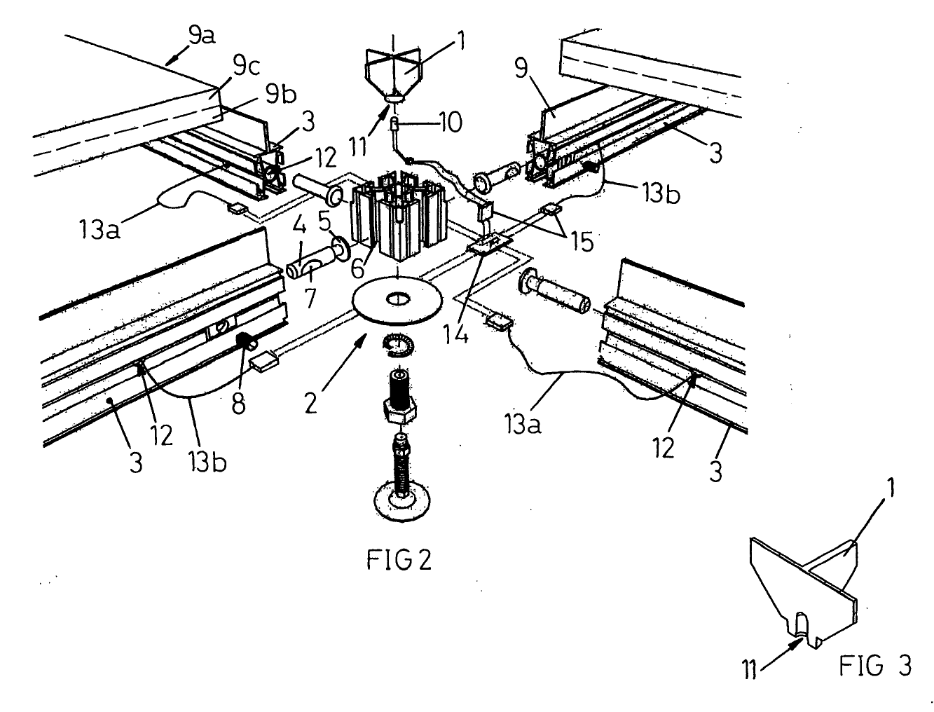

Several ducts 12 intended to house the wiring that is going to feed the diodes have been fitted to the girders 3. The wiring is constructed in the way of a matrix, by rows 13a and columns 13b, as may be seen in FIG. 1, which allows the selective or individual illumination of sets of diodes. For the individual connection of each diode, a tapping plate 14 has been provided on each leg that will also provide continuity for the cable buses that converge there, the different connections with the plate being carried out through the corresponding connectors.

In the same way, according to the invention, it is possible to carry out the wiring for buses, instead of through physical wires, through the sections of the reticulated network itself, given its metallic nature, with the obvious implementation of isolation at the crossing points, that is to say, at the adjustable legs, as well as the connections that give continuity to the buses and branch towards the diodes or luminous elements being used.

The cable buses arranged in rows and columns are each independently connected to distribution frames 16, and these in turn to a control processing board 17 that precisely controls switching on and off, as well as the brightness and intensity of all the diodes comprising the installation, and, in installations with bicoloured LED, the resultant colour. The processing board has a module processed for the generation of luminous effects and the creation of ways for signalling using control software. The configuration of this control board includes connection to an external computer.

Given that the system in the invention may be preferably used for emergency signalling, it has been established that the power supply 19 of the diodes comes from a safe source, which is also responsible for supplying electric power to the control board. Thus it is possible to configure automatic operation input in case of emergency, even in the case of electrical power failure.

Having sufficiently described the nature of the invention, as well as the way to embody it in practice, it must be emphasized that the previously indicated layouts, represented in the attached drawings, may be modified in detail as long as they do not alter the fundamental principle.

1. System for signalling and/or decorative lighting on technical floors, on the type of floors comprising a number of height-adjustable legs connected by means of girders forming a horizontal network structure which may be levelled, on which a number of floor-creating plates are set; comprising a number of luminous or luminescent elements arranged so as to notice their illumination, protected in several holes made inside or between the plates forming the technical floor, power being supplied to them through the corresponding wiring from a preferably safe power supply.

2. System according to claim 1, comprising the luminous or luminescent elements being preferably fitted in the area of the adjustable legs of the floor structure.

3. System according to claim 1, comprising the holes housing the luminous or luminescent elements being preferably fitted by means of a separation of the plates forming the floor.

4. System according to claim 2, comprising the separation being arranged by way of upper, longitudinal wings jutting out from the girders of the reticulated structure that do not continue over the structure's adjustable legs, this discontinuity defining the luminous or luminescent element visualization holes fitted in this area.

5. System according to claim 3, comprising the separation being made by chamfers or gaps in the plates around their perimeter, and preferably at their corners.

6. System according to claim 1, comprising covering the holes with luminous diffusers, in a suitable way to protect the luminous or luminescent elements and diffusers themselves.

7. System according to claim 6, comprising the diffusers having a shape corresponding to that of the hole where they are placed.

8. System according to claim 6, comprising the diffusers remaining flush with the surface of the technical floor.

9. System according to claim 6, comprising the diffusers having a transparency between 72 and 89%, having tinting on their upper face.

10. System according to claim 4, comprising the diffuser having a general cross-shape to be fitted into the hole between four plates adjacent to a leg, in a non-perimeter zone of the technical floor.

11. System according to claim 4, comprising the diffuser having a general T-shape to be fitted into the hole between two plates adjacent to a leg, in a non-perimeter zone of the technical floor.

12. System according to claim 1, comprising the fact that a single or multicoloured LED diode is used as luminescent element.

13. System according to claim 6, comprising each diffuser being fitted with a hole to house the luminous or luminescent element.

14. System according to claim 1, comprising the power-supply wiring of the luminous or luminescent elements being constructed matrix-wise in rows and columns, comprising cable buses that independently feed each row and column, and the column buses being interconnected on one side and the rows on the other each to distribution frames connected to a processing board that controls the selective switching on/off of the above mentioned luminous or luminescent elements, and, if possible, their colour and brightness.

15. System according to claim 14, comprising the processing board having a module processed for the generation of luminous effects and the creation of ways for signalling using control software; the processing board is connected to an outer computer for configuration.

16. System according to claim 14, comprising the connection or branch connection to each luminous or luminescent element from the corresponding cable buses being made through a connection plate, that in turn carries out the continuity of the above mentioned buses.

17. System according to claim 2, comprising the case where the luminous or luminescent elements are fitted into the legs of the structure, there is a connection plate on each of the aforementioned legs.

18. System according to claim 1, comprising including ducting through which the wiring is passed, fitted inside the girders making the technical floor structure.

19. System according to claim 1, comprising the wiring buses being alternatively carried out by the girders themselves that form the network structure, having included isolators at their crossing points corresponding to the adjustable legs, in order to avoid short circuits, as well as bus continuity connections and power supply to the luminous or luminescent elements that are located in the corresponding leg.
